(19) United States
(12) Patent Application Publication
(10) Pub. No.: US 2008/0015906 A1
(43) Pub. Date: Jan. 17, 2008

(54) Weather Insurance

(76) Inventor: Henry L. Fox, Manhasset, NY (US)

Correspondence Address: WILLIAM COLLARD;COLLARD & ROE, P.C., 1077 NORTHERN BOULEVARD, ROSLYN, NY, 11576, US

(21) Appl. No.: 11/587,684

(22) PCT Filed: Apr. 29, 2004
(86) PCT No.: PCT/US04/13193

§ 371 Date: Oct. 26, 2006

(51) Int. Cl. G06Q 40/00

(52) U.S. Cl. 705/4

(57) ABSTRACT

A method of insuring against a specified weather condition being outside of a specified limit in two consecutive years or in a single year. Data is acquired regarding the specified weather condition in past years. The number of occurrences is determined the specified weather condition being outside the specified limit at the specified geographic site in two consecutive years, or in a single year, during the preselected number of years. The probability is determined of the specified weather condition being outside the specified limit at the specified geographic site in the two specified consecutive years or the specified year. The premium for a policy ensuring in the face amount A is based on the determined probability. The past occurrences might be weighted based on the year of the occurrence, and the payout might be a percentage of the face amount based on the extent to which the weather condition is outside the specified limit.

### AREA OF THE INVENTION

The present invention pertains to weather insurance. More particularly, the present invention pertains to a method of determining the probability of the average value of a specified weather condition during a specified season in two specified consecutive years, or the value during a specified season in a single specified year, being outside of a specified limit for the weather condition in a specified geographic site. In addition, the present invention pertains to a method of preparing a weather insurance policy insuring against such occurrence.

### BACKGROUND OF THE INVENTION

Insurance providing coverage against extreme weather conditions is an important financial instrument. A significant market for weather insurance is, for example, the energy industry. By way of example, an electric utility needs to assure that it can afford to obtain the necessary electricity for its customers in the event of an unexpectedly severe or lengthy hot spell when demands for air conditioning are high. While the necessary electricity may be available, the cost to the electric utility can become an obstacle to profitability, particularly if its customers have contracts under which the utility is obligated to sell electricity to the customers at a preset price. The price which the electric utility must pay for the electricity may increase considerably in the event of unexpectedly hot weather for a long period of time.

Likewise, a gas utility needs to assure that it can afford to obtain all the gas demanded by its customers for heating in the event of unexpectedly cold weather for a lengthy period of time.

To enable more accurate estimates of their needs for electricity or heating gas, utilities in the United States, for example, describe temperature in terms of cooling degree days and heating degree days, as defined by the United States National Weather Service for specific geographic sites. A cooling degree day at a site is a day on which the average temperature at the site for the day—that is, the average of the day's lowest temperature and the day's highest temperature—is one degree Fahrenheit above 65° F. Thus, for example, if the lowest temperature at a particular site is 63° F. on a given day and the highest temperature is 91° F. the average temperature that day at that site is 77° F., and that constitutes 12 cooling degree days.

Conversely, a heating degree day at a site is a day on which the average temperature at the site is one degree Fahrenheit below 65° F. Thus, for example, if the lowest temperature at a particular site is 50° F. on a given day and the highest temperature is 64° F., the average temperature that day at that site is 57° F., and that constitutes 8 heating degree days.

In the following discussion, “temperature degree days” will be used as a generic term for cooling degree days and heating degree days.

Utilities may wish to assure that they do not have a severe economic loss, and so the utilities generally obtain quotations for weather insurance against the occurrence of an extreme number of cooling degree days or heating degree days in a given year. By way of example, an electric utility may wish to obtain insurance against there being more than a specified number of cooling degree days in a year. Likewise, a gas utility may wish to obtain insurance against there being more than a specified number of heating degree days in a year. Alternatively, a utility may wish to obtain insurance against there being more than a specified number of heating or cooling degree days during a specified season of the year, such as a specified number of heating degree days during the months of December, January, and February when heating requirements are highest, or a specified number of cooling degree days during the months of June, July, and August when air conditioning usage is highest.

Another important market for weather insurance is the agricultural industry. Farmers are dependent upon there being an appropriate quantity of rain each year. If there is either too little rain or too much rain, crops may not grow well, with economic damage to the farmer. Consequently, farmers frequently seek insurance against either rain of less than a first specified quantity of rain of more than a second specified quantity, or both, during the growing season of any year.

Insurance companies issuing policies insuring against extreme weather conditions determine the premium they charge for the insurance by consulting historical records of weather conditions. For example, to determine the premium for a policy insuring against the occurrence of an extreme number of temperature degree days, the insurance companies consult historical records of heating degree days or of cooling degree days in prior years for a specific geographic site. Such records are available from the National Climatic Data Center. However, the occurrence of one year of extreme weather is not all that unusual. Consequently, the premium to insure against a single year of an extreme number of heating degree days or cooling degree days is often higher than a utility may feel that it wants to pay, and so the utility may feel that it would rather self-insure the risk, buying the necessary heating gas or the necessary electricity, even at high prices, rather than to pay what it considers to be an unacceptably high premium for the insurance.

Similarly, farm operators may wish insurance against there being too little rain during the growing season in any single year. For example, a farm operator may wish to insure against there being less than 4 inches of rain during June, July, and August of a particular year. Again, sites from the National Climatic Data Center or other sources, insurance companies can obtain historical records of the quantity of rain that fell in past years at various geographical sites. From this data, they can determine the probability of there being less than a specified quantity of rain during any specified period of the year, and so can determine the premium for a policy insuring against there being less than the specified quantity of rain during the specified season in a specified year.

However, if an extreme weather condition was experienced in a single year many years in the past, equal consideration of that year in determining the premium may result in the premium being higher than is justified by weather conditions during more recent years. For example, if an unusual drought 40 years in the past caused an extremely low quantity of rain during that one year, equal consideration of that year will distort the determined probability of there being less than the specified quantity of rain during the current year.

In addition, the farm operator may feel that, although at least 4 inches of rain is desired during the growing season, nevertheless if there is at least 1 inch of rain, its crops will survive, although perhaps having a lower market value. Consequently, the farm operator may prefer a policy in which the payout is dependent upon the extent to which the total rain is below the specified limit, such as 4 inches.

### SUMMARY OF THE INVENTION

The present invention pertains to insuring against an extreme weather condition at a reasonable price. While the present invention will be described primarily with reference to insurance against an excessive number of temperature degree days or against an excessively low or excessively high quantity of rain during a growing season, the invention is applicable to extremes of other weather conditions as well.

In one aspect, the present invention is a method of insuring against the average value of a specified weather condition during a specified season in two specified consecutive years being outside of a specified limit for the weather condition at a specified geographic site. In a second aspect, the present invention is a method of insuring against the occurrence at a specified geographic site of a specified weather condition outside of a specified limit for the weather condition during a specified season in a specified year. The specified geographic site is preferably at a National Weather Service Recording Station. The specified season might be a portion of the year or the full calendar year. In accordance with a further aspect of the invention, a policy insuring against such an occurrence is prepared.

By way of example, to prepare a policy insuring against the average annual number of heating degree days during the heating season in two specified consecutive years being in excess of a specified number D of heating degree days at a specified geographic site, data is acquired, including the number of heating degree days at the specified geographic site during the heating season in each of a preselected number N of years prior to the two specified consecutive years.

In one embodiment of the invention, the number T is determined of occurrences of the average number of heating degree days exceeding the specified number D of heating degree days during the heating season in two consecutive years during the preselected number N of years. From the number T of occurrences and the preselected number N of years, the probability L is determined of there being at the specified geographic site an average number of heating degree days during the specified season in the two specified consecutive years in excess of the specified number D of heating degree days. In a preferred embodiment, the probability L is determined as L=T÷N. Preferably, N is a number sufficient to give meaningful results, for example 30 or more.

In another embodiment of the present invention, the occurrences are identified of the average number of heating degree days exceeding the specified number D of heating degree days during the specified season in two consecutive years during the preselected number N of years. Again, N is preferably 30 or more. Each year in the preselected number N of years is weighted on the basis of the inverse of the number of years between such year and the first year of the two specified consecutive years, and each identified occurrence is weighted on the basis of the weight of one of its two consecutive years to give a weighted number for each such occurrence. From the weighted years and the weighted numbers of the occurrences, the probability L is determined of the average number of heating degree days at the specified geographical site during the specified season in the two specified consecutive years exceeding the specified number D of heating degree days.

The years in the preselected number of years may be weighted by assigning to each of the years a value V equal to one more than the number D of years between that year and the first one of the N years, and totaling the values V to give a total weighted number Y for the years.

Each occurrence may be weighted by the value V of one of its two specified consecutive years. The weighted numbers of the occurrences may be totaled to give a total weighted number W for the occurrences, and probability L may be determined as L=W÷Y.

By substituting cooling degree days for heating degree days, the same method may be used to prepare a policy insuring a customer against the occurrence of an average number of cooling degree days in excess of a specified number D of cooling degree days at a specified site during a specified season in two specified consecutive years.

Other aspects of the present invention include determining the premium P for a policy insuring in a specified amount A against the average value of the specified weather condition during the specified season in the two specified consecutive years outside of the specified limit at the specified geographic site, and preparing the policy. The premium might be determined as P=(L+E)×A, where E is a value to account for overhead and profit. Preferably, E results in a premium providing a break even point of approximately 65%±10%. Alternatively, the premium P may be determined as P=L×A×C, where C is a constant to account for overhead and profit. For a break even point of approximately 67%, then, C is 1.5. As another alternative, the premium P may be determined as P=L×A+E, where E is overhead and profit. Other techniques for determining the premium P might also be used.

Preferably, also the invention further comprises acquiring from a customer identification of the customer, the specified amount A of insurance desired by the customer for the policy, the specified geographic site, the specified weather condition, the specified limit, the specified season, and the two specified consecutive years. As an illustration, a heating gas supplier might want a policy providing $1,000,000 of insurance against there being in Kansas City, Mo. an average of more than 5500 heating degree days in each of the years 2003 and 2004. The company then would provide its name as the customer identification, the number $1,000,000 as the specified amount A of insurance desired, Kansas City, Mo. as the specified geographic site, an excessive number of heating degree days as the specified weather condition, 5500 as the specified limit D, the calendar year as the specified season, and 2003 and 2004 as the two specified consecutive years. The probability L of the average number of heating degree days during the calendar years 2003 and 2004 exceeding 5500 in Kansas City, Mo. would be determined from historical temperature data for that site, and the policy premium P determined. If the utility agreed, the policy would then be issued by the insurance company.

In another aspect, the present invention is a method of determining the probability L of occurrence at a specified geographic site of a specified weather condition outside of a specified limit for the weather condition during a specified season in a single specified year. By way of example, to determine the probability L of rain of less than a specified quantity at a particular site during a specified season in a specified year, data is acquired regarding the quantity of rain at the specified geographic site during the specified season in each of a preselected number N of years prior to the specified year. From the data, the occurrences at the specified geographic site are identified of the years in which the quantity of rain was less than the specified quantity during the specified season in the preselected number N of years. Each year in the preselected number N of years is weighted on the basis of the number of years between such year and the specified year, and each identified occurrence is weighted on the basis of the weight of its corresponding year. From the weighted years and the weighted occurrences, the probability L is determined of there being less than the specified quantity of rain at the specified geographic site in the specified year.

Again, the premium can be determined for a policy insuring against the specified weather condition being outside the specified limit at the specified geographic site during the specified season in the specified year, the necessary information obtained from the customer, and the policy prepared and issued.

If desired, a set of payout percentages can be assigned to a set of triggering conditions, each triggering condition representing a preselected amount of the preselected limit, and each payout percentage representing a preselected percentage of the amount A to be paid in the event the associated triggering condition is met during the preselected season in the two preselected consecutive years or in the preselected year. Thus, for example, a farm operator may be concerned about there being less than four inches of rain during the growing season of the coming year, but the operator may feel that if there is an inch or more rain during that season, its crops will survive, although less well. Therefore, the farm operator may want insurance which will compensate it in an amount which varies in accordance with the quantity of rain during the growing season. In accordance with the present invention, the farm operator may obtain, for example, a policy insuring in the face amount A against there being less than four inches of rain at the site of its farm, with the policy paying the amount A in the event there is less than one inch of rain, an amount equal to 75% of A in the event there is between one inch and two inches of rain, an amount equal to 50% of A in the event there is between two inches and three inches of rain, and an amount equal to 25% of A in the event there is between three and four inches of rain.

### BRIEF DESCRIPTION OF THE DRAWINGS

These and other aspects and advantages of the present invention are more apparent from the following detailed description and claims, particularly when considered in conjunction with the accompanying drawings. In the drawings:

FIG. 1 is a flow chart of a first embodiment of a method in accordance with the present, invention;

FIG. 2 is a flow chart of a second embodiment of a method in accordance with the present invention; and

FIG. 3 is a block diagram of an embodiment of a system for performing a method in accordance with the invention.

### DETAILED DESCRIPTION

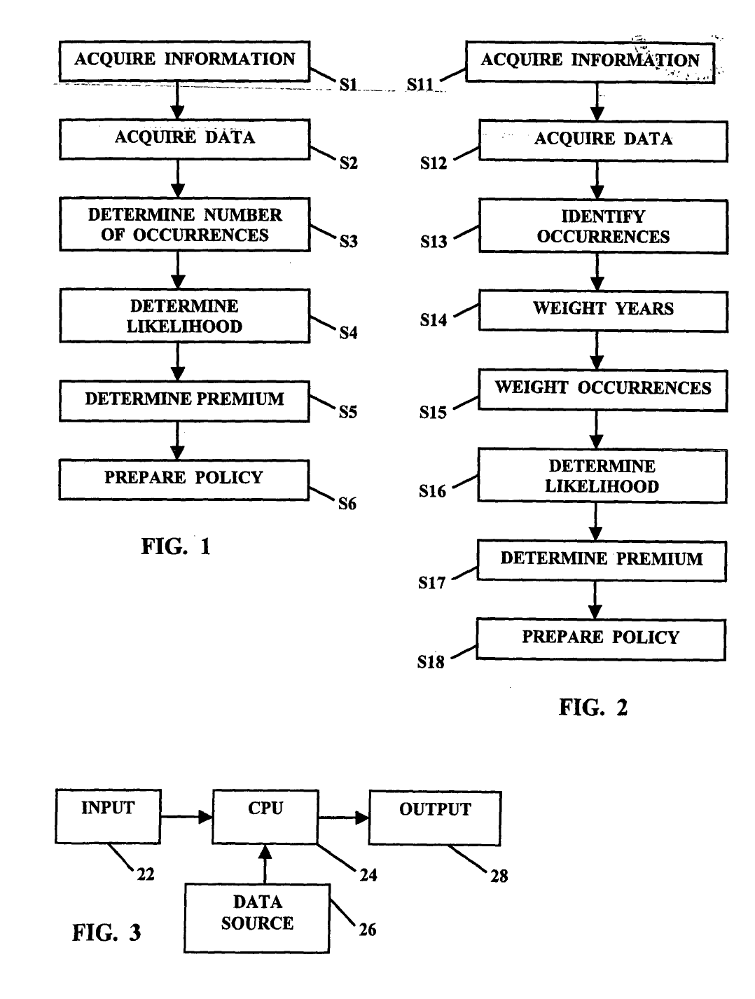

FIG. 1 is a flow chart of a first embodiment of a method in accordance with the present invention. In accordance with the exemplary method of FIG. 1, to prepare a policy insuring a customer such as a utility in an amount A against the average value of a specified weather condition during a specified season in two specified consecutive years being outside a specified limit for the weather condition, such as the number of heating degree days exceeding a specified number D of heating degree days, information is acquired from the customer, including identification of the customer, the specified amount A, the specified geographic site, the specified weather condition (heating degree days), the specified limit (the number D), the specified season, and the two specified consecutive years (Step S1). Data is acquired, including the number of heating degree days at the specified geographic site during the specified season in each of a preselected number N of years prior to the two specified consecutive years (Step S2).

From the data, the number T is determined of occurrences of the average number of heating degree days exceeding the specified number D during the specified season in any two specified consecutive years during the preselected number N of years (Step S3). From the number T of occurrences and the preselected number N of years, the probability L is determined of the average number of heating degree days exceeding the specified number D of heating degree days during the specified season in the two specified consecutive years (Step S4). In the embodiment of FIG. 1, the probability L might be determined in various ways, such as L=T÷N.

The premium P for the policy may then be determined, for example, as P=(L+E)×A, where E is a value to provide overhead and profit. Preferably, E results in a premium providing a break even point in the range of about 65%±10%. Alternatively, the premium P might be determined as P=L×A×C, where C is a constant to account for overhead and profit, and, for a break even point of approximately 67%, C may be 1.5. As another alternative, the premium P might be determined as P=L×A+E, where E is overhead and profit. Other techniques for determining the premium P might also be used.

If the customer accepts the weather insurance policy at the determined premium, the policy is then prepared (Step S6).

By substituting cooling degree days for heating degree days, the same method may be used to prepare a policy insuring a customer against the probability of occurrence during a specified season in two specified consecutive years of a number of cooling degree days in excess of a specified number D of cooling degree days. Likewise, any other weather condition could be substituted.

FIG. 2 is a flow chart of a second embodiment of a method in accordance with the present invention in which each occurrence is weighted based on the year of occurrence. In accordance with the exemplary method of FIG. 2, to prepare a policy insuring a customer in an amount A against the average value of a specified weather condition being outside of a specified limit for the weather condition during a specified season in two specified consecutive years, such as the number of heating degree days exceeding a specified number D of heating degree days, information is acquired from the customer, including identification of the customer, the specified amount A, the specified geographic site, the specified weather condition (for example, heating degree days) the specified limit (for example the number D) the specified season, and the two specified consecutive years (Step S11). Data is acquired, including the number of heating degree days at the specified geographic site during the specified season in each of a preselected number N of years prior to the two specified consecutive years (Step S12). From the data, the occurrences are identified of the average number of heating degree days exceeding the specified number D of heating degree days during the specified season in two consecutive years during the preselected number N of years (Step S13).

Each year in the preselected number N of years is weighted on the basis of the inverse of the number of years since such year (Step S14), and each identified occurrence is weighted on the basis of the weight of one of its two consecutive years to give a weighted number for each such occurrence (Step S15). From the weighted years and the weighted numbers of the occurrences, the probability L is determined of the average number of heating degree days being in excess of the specified number D of heating degree days at the specified geographical site during the specified season in the two specified consecutive years (Step S16).

The years in the preselected number of years may be weighted by assigning to each of the years a value V equal to one more than the number of years between that year and the first one of the N years, and totaling the values V to give a total weighted number Y for the years.

Each occurrence may be weighted by the value V of one of its two consecutive years, the weighted numbers of the occurrences may be totaled to give a total weighted number W for the occurrences, and the probability L may be determined as L=W÷Y.

The premium P for the policy is then determined (Step S17). Again, the premium might be determined as P=(L+E)×A, where E is a value to provide overhead and profit. Preferably, E results in a premium providing a break even point of in the range of about 65%±10%. Alternatively, the premium P may be determined as P=L×A×C, where C is a constant to account for overhead and profit, and, for a break even point of approximately 67%, C may be 1.5. As another alternative, the premium P may be determined as P=L×A+E, where E is overhead and profit. Other techniques for determining the premium P might also be used.

If the customer accepts the policy at the determined premium, the weather insurance policy is then prepared (Step S18).

Again, by substituting any other specified weather condition for heating degree days, the same method may be used to prepare a policy insuring a customer against the average value of that weather condition being outside a specified value for the weather condition during a specified season in two specified consecutive years at a specified geographical site.

Table 1 illustrates a hypothetical example of the weighting of the years and of the occurrences in accordance with a preferred embodiment of the invention in which the two specified consecutive years are 2003 and 2004, the specified number D is 6000 heating degree days (“HDD”), the occurrences are weighted on the basis of the weight of the second of the two consecutive years, and the number N of years prior to the two specified consecutive years is 30. With heating degree days, the year runs from July 1 to June 30.

TABLE 1

| | | TWO YEAR | AVERAGE | WEIGHTED | WEIGHTED |
|---|---|---|---|---|---|
| YEAR | HDD | AVERAGE | OVER 6000 | YEAR VALUE V | OCCURRENCE VALUE |
| 1973-74 | 4895 | — | — | 1 | 0 |
| 1974-75 | 5851 | 5373 | — | 2 | 0 |
| 1975-76 | 6320 | 6086 | X | 3 | 3 |
| 1976-77 | 5581 | 5951 | — | 4 | 0 |
| 1977-78 | 6151 | 5866 | — | 5 | 0 |
| 1978-79 | 5043 | 5597 | — | 6 | 0 |
| 1979-80 | 5933 | 5488 | — | 7 | 0 |
| 1980-81 | 6337 | 6135 | X | 8 | 8 |
| 1981-82 | 5654 | 5996 | — | 9 | 0 |
| 1982-83 | 5311 | 5483 | — | 10 | 0 |
| 1983-84 | 6041 | 5676 | — | 11 | 0 |
| 1984-85 | 5330 | 5686 | — | 12 | 0 |
| 1985-86 | 5287 | 5309 | — | 13 | 0 |
| 1986-87 | 4691 | 4939 | — | 14 | 0 |
| 1987-88 | 5152 | 4922 | — | 15 | 0 |
| 1988-89 | 5060 | 5106 | — | 16 | 0 |
| 1989-90 | 5757 | 5409 | — | 17 | 0 |
| 1990-91 | 6613 | 6185 | X | 18 | 18 |
| 1991-92 | 4950 | 5782 | — | 19 | 0 |
| 1992-93 | 5253 | 5102 | — | 20 | 0 |
| 1993-94 | 5410 | 5332 | — | 21 | 0 |
| 1994-95 | 4877 | 5144 | — | 22 | 0 |
| 1995-96 | 5683 | 5280 | — | 23 | 0 |
| 1996-97 | 5691 | 5687 | — | 24 | 0 |
| 1997-98 | 4801 | 5246 | — | 25 | 0 |
| 1998-99 | 4557 | 4679 | — | 26 | 0 |
| 1999-00 | 4287 | 4422 | — | 27 | 0 |
| 2000-01 | 5623 | 4955 | — | 28 | 0 |
| 2001-02 | 4536 | 5080 | — | 29 | 0 |
| 2002-03 | 5155 | 4896 | — | 30 | 0 |
| Totals | | | 3 | Y = 465 | W = 29 |

In the example of Table 1, the two consecutive years 1973-74 and 1974-75 had an average of 5373 heating degree days, and since that is fewer than the specified number D of 6000 heating degree days, the 1973-74 and 1974-75 years were not an occurrence. The 1975-76 year had 6320 heating degree days, and so the average for the two consecutive years 1974-75 and 1975-76 was 6086, exceeding the specified number D of 6000 heating degree days. Consequently, the 1974-75 and 1975-76 years were an occurrence.

In accordance with the first embodiment above, in the example of Table 1 there were 3 occurrences during the 30 years, and so the probability L may be calculated as L=T÷N or L=3÷30=0.200. If the customer wants, for example, coverage of $1,000,000 and the overhead and expense figure is 0.100 in order to give a break even point of 66.7%, then the premium P may be given by P=(L+E)×A or P=(0.200+0.100)×$1,000,000=$300,000. If the customer agrees to that premium, the policy can be written and issued. If that is more than the customer is willing to pay for the insurance, a higher specified number D of heating degree days can be used, resulting in a lower premium.

In accordance with the second embodiment above, in the example of Table 1 the weighted year value V for the 1975-76 occurrence year, for example, is V=(1976−1974+1)=3, and so the weighted number for this occurrence is 3. The total weighted occurrence value W=29, and the total weighted year value Y=465. Therefore the probability L =W +Y is L=29÷465=0.062. If the customer wants, for example, coverage of $1,000,000 and the overhead and expense figure is 0.033, then the premium P may be given by P=(L+E)×A or P =(0.062+0.033)×$1,000,000=$95,000. Again, if the customer agrees to that premium, the policy can be written and issued, but if that is more than the customer is willing to pay for the insurance, a higher specified number D of heating degree days can be used, resulting in fewer occurrences, and so a lower premium.

Further, a policy insuring for only a season of the year, or for any specified period of days, can be issued by determining the probability from the heating degree days for the corresponding season or period of days in the N prior years. Additionally, the premium P may be determined as P=L×A×C, where C is a constant to account for overhead and profit, with, for example, C=1.5. As another alternative, the premium P may be determined from P=L×A+E, where E is overhead and profit. Other techniques for determining the premium P might also be used.

As another example of the method of FIG. 2, a policy can be prepared insuring a farm operator in an amount A against the average quantity of rain at the geographical site at which the farm is located being less than a specified amount, such as 4 inches, during a growing season, for example, the months of June, July, and August, in a specified year. Information is acquired from the customer, including identification of the customer, the specified amount A, the specified geographic site, the specified weather condition (too little rain), the specified limit (4 inches), the specified season (June, July, and August), and the specified year (Step S11). Data is acquired, including the quantity of rain at the specified geographic site during June, July, and August in each of a preselected number N of years prior to the specified year (Step S12). From the data, the occurrences are identified of the quantity of rain during June, July, and August in any year of the N years being less than 4 inches (Step S13).

Each year in the preselected number N of years is weighted on the basis of the inverse of the number of years since such year (Step S14), and each identified occurrence is weighted on the basis of the weight of its year to give a weighted number for each such occurrence (Step S15). From the weighted years and the weighted numbers of the occurrences, the probability L is determined of the quantity of rain at the specified geographical site being less than the specified amount D during the specified season in the specified year (Step S16).

The premium can be determined for a policy insuring in an amount A against there being less than 4 inches of rain at the specified geographical site during June, July, and August in the specified year (Step S17). If the customer accepts the policy at the determined premium, the policy is prepared (Step S18).

Table 2 illustrates a hypothetical example of the weighting of the years and of the occurrences in which the specified season is the months of June, July, and August, the specified year is 2004, the specified condition is too little rain, the specified limit D is 4 inches, and the number of years N is 30.

TABLE 2

| | RAIN | RAIN LESS | WEIGHTED | WEIGHTED | TRIGGERED | TRIGGERED |
|---|---|---|---|---|---|---|
| YEAR | AMOUNT | THAN 4″ | YEAR VALUE V | OCCURRENCE VALUE | PAYOUT % | OCCURRENCE VALUE |
| 1974 | 7.0 | — | 1 | 0 | 0 | 0.0 |
| 1975 | 4.8 | — | 2 | 0 | 0 | 0.0 |
| 1976 | 5.3 | — | 3 | 0 | 0 | 0.0 |
| 1977 | 6.7 | — | 4 | 0 | 0 | 0.0 |
| 1978 | 0.5 | X | 5 | 5 | 100% | 5.0 |
| 1979 | 8.1 | — | 6 | 0 | 0 | 0.0 |
| 1980 | 4.7 | — | 7 | 0 | 0 | 0.0 |
| 1981 | 6.0 | — | 8 | 0 | 0 | 0.0 |
| 1982 | 5.8 | — | 9 | 0 | 0 | 0.0 |
| 1983 | 1.8 | X | 10 | 10 | 75% | 7.5 |
| 1984 | 8.4 | — | 11 | 0 | 0 | 0.0 |
| 1985 | 6.1 | — | 12 | 0 | 0 | 0.0 |
| 1986 | 4.9 | — | 13 | 0 | 0 | 0.0 |
| 1987 | 7.3 | — | 14 | 0 | 0 | 0.0 |
| 1988 | 5.3 | — | 15 | 0 | 0 | 0.0 |
| 1989 | 5.7 | — | 16 | 0 | 0 | 0.0 |
| 1990 | 5.4 | — | 17 | 0 | 0 | 0.0 |
| 1991 | 3.4 | X | 18 | 18 | 25% | 4.5 |
| 1992 | 4.6 | — | 19 | 0 | 0 | 0.0 |
| 1993 | 6.0 | — | 20 | 0 | 0 | 0.0 |
| 1994 | 7.7 | — | 21 | 0 | 0 | 0.0 |
| 1995 | 5.8 | — | 22 | 0 | 0 | 0.0 |
| 1996 | 7.3 | — | 23 | 0 | 0 | 0.0 |
| 1997 | 2.7 | X | 24 | 24 | 50% | 12.0 |
| 1998 | 5.6 | — | 25 | 0 | 0 | 0.0 |
| 1999 | 6.0 | — | 26 | 0 | 0 | 0.0 |
| 2000 | 7.3 | — | 27 | 0 | 0 | 0.0 |
| 2001 | 5.0 | — | 28 | 0 | 0 | 0.0 |
| 2002 | 4.5 | — | 29 | 0 | 0 | 0.0 |
| 2003 | 7.3 | — | 30 | 0 | 0 | 0.0 |
| Totals | | 4 | Y = 465 | W₁ = 57 | | W₂ = 29.0 |

In the example of Table 2, 1978, 1983, 1991, and 1997 had less than 4 inches of rain during June, July, and August. These years had weighted occurrence values, respectively, of 5, 10, 18, and 24, and so the total occurrence value W₁=57, while the total weighted years Y=465. Therefore, the probability L=W₁÷Y is L=57÷465=0.123. Based on this probability, the premium can be determined for a policy insuring in an amount A against there being less than 4 inches of rain at the specified geographical site during June, July, and August in the specified year, and if the customer accepts the policy at the determined premium, the policy is prepared. By way of example, the premium can be determined as above as P=(L+E)×A.

This L value may result in a premium for the insurance policy that is higher than the farm operator is willing to pay. The farm operator may believe that, while 4 inches of rain is needed for optimum crop growth, acceptable crops may be grown with less rain, although with less profit. Consequently, the farm operator may accept a policy in which the payout is dependent upon the extent to which the total rain is below the specified limit, such as 4 inches. Table 2 illustrates a set of triggering conditions for a policy insuring in a face amount A with a payout of the amount A in the event there is less than one inch of rain, a payout of 75% of A in the event there is between one inch and two inches of rain, a payout of 50% of A in the event there is between two inches and three inches of rain, and a payout of 25% of A in the event there is between three and four inches of rain. In the example of Table 2, the occurrence year 1978 has a weighted occurrence value of 5, and 0.5 inch of rain, and so a triggered payout percentage of 100%, giving a triggered occurrence value of 5.0. The occurrence year 1983 has a weighted occurrence value of 10, and 1.8 inches of rain, and so a triggered payout percentage of 75%, giving a triggered occurrence value of 7.5. The occurrence year 1991 has a weighted occurrence value of 18, and 3.4 inches of rain, and so a triggered payout percentage of 25%, giving a triggered occurrence value of 4.5. The occurrence year 1997 has a weighted occurrence value of 24, and 2.7 inches of rain, and so a triggered payout percentage of 50%, giving a triggered occurrence value of 12.0. The total of the triggered occurrence values is thus W₂=29.0, and so the probability L=W₂÷Y is L=29÷465=0.063. The premium can be determined for a policy insuring in a face amount A against there being less than 4 inches of rain at the specified geographical site during June, July, and August in the specified year, with the payout under the policy being dependent upon the extent to which the quantity of rain is lower than 4 inches. Again, by way of example, the premium can be determined as P=(L+E)×A. If the customer accepts the policy at the determined premium, the policy is prepared

Table 3 illustrates a hypothetical example of a set of triggering conditions for a policy insuring against an excessive average number of heating degree days during the years 2003 and 2004. The policy has a face amount A with a payout of 100% of A in the event there is an average of more than 6200 heating degree days during those years, an amount equal to 80% of A in the event there are between 6100 and 6200 heating degree days, an amount equal to 60% of A in the event there are between 6000 and 6100 heating degree days, an amount equal to 40% of A in the event there are between 5900 and 6000 heating degree days, and an amount equal to 20% of A in the event there are between 5800 and 5900 heating degree days.

TABLE 3

| | | TWO YEAR | AVERAGE | WEIGHTED | WEIGHTED | | TRIGGERED |
|---|---|---|---|---|---|---|---|
| YEAR | HDD | AVERAGE | OVER 5800 | YEAR VALUE V | OCCURRENCE VALUE | PAYOUT % | OCCURRENCE VALUE |
| 1973-74 | 4895 | — | — | 1 | 0 | 0 | 0 |
| 1974-75 | 5851 | 5373 | — | 2 | 0 | 0 | 0 |
| 1975-76 | 6320 | 6086 | X | 3 | 3 | 60% | 1.8 |
| 1976-77 | 5581 | 5951 | X | 4 | 4 | 40% | 1.6 |
| 1977-78 | 6151 | 5866 | X | 5 | 5 | 20% | 1.0 |
| 1978-79 | 5043 | 5597 | — | 6 | 0 | 0 | 0 |
| 1979-80 | 5933 | 5488 | — | 7 | 0 | 0 | 0 |
| 1980-81 | 6337 | 6135 | X | 8 | 8 | 80% | 6.4 |
| 1981-82 | 5654 | 5996 | X | 9 | 9 | 40% | 3.6 |
| 1982-83 | 5311 | 5483 | — | 10 | 0 | 0 | 0 |
| 1983-84 | 6041 | 5676 | — | 11 | 0 | 0 | 0 |
| 1984-85 | 5330 | 5686 | — | 12 | 0 | 0 | 0 |
| 1985-86 | 5287 | 5309 | — | 13 | 0 | 0 | 0 |
| 1986-87 | 4691 | 4939 | — | 14 | 0 | 0 | 0 |
| 1987-88 | 5152 | 4922 | — | 15 | 0 | 0 | 0 |
| 1988-89 | 5060 | 5106 | — | 16 | 0 | 0 | 0 |
| 1989-90 | 5757 | 5409 | — | 17 | 0 | 0 | 0 |
| 1990-91 | 6613 | 6185 | X | 18 | 18 | 80% | 14.4 |
| 1991-92 | 4950 | 5782 | — | 19 | 0 | 0 | 0 |
| 1992-93 | 5253 | 5102 | — | 20 | 0 | 0 | 0 |
| 1993-94 | 5410 | 5332 | — | 21 | 0 | 0 | 0 |
| 1994-95 | 4877 | 5144 | — | 22 | 0 | 0 | 0 |
| 1995-96 | 5683 | 5280 | — | 23 | 0 | 0 | 0 |
| 1996-97 | 5691 | 5687 | — | 24 | 0 | 0 | 0 |
| 1997-98 | 4801 | 5246 | — | 25 | 0 | 0 | 0 |
| 1998-99 | 4557 | 4679 | — | 26 | 0 | 0 | 0 |
| 1999-00 | 4287 | 4422 | — | 27 | 0 | 0 | 0 |
| 2000-01 | 5623 | 4955 | — | 28 | 0 | 0 | 0 |
| 2001-02 | 4536 | 5080 | — | 29 | 0 | 0 | 0 |
| 2002-03 | 5155 | 4896 | — | 30 | 0 | 0 | 0 |
| Totals | | | | Y = 465 | | | W = 28.8 |

As can be seen from Table 3, in that example the total of the triggered occurrence values is 28.8, and so the probability L=W÷Y is L=28.8÷465=0.062. From this value of L, the premium can be determined for a policy insuring in a face amount A against there being an average of more than 5800 heating degree days in the years 2003 and 2004, with the payout under the policy being dependent upon the extent to which the average is greater than 5800. Once more by way of example, the premium can be determined as P=(L+E)×A. If the customer accepts the policy at the determined premium, the policy is prepared.

FIG. 3 is a block diagram of a system in accordance with an embodiment of the invention for performing a method of the invention. Information, including identification of the customer, the specified amount A, the specified geographic site, the specified weather condition, the specified limit for the specified weather condition, the specified season and the specified year or the two specified consecutive years, is applied by input unit 22 to central processing unit 24. Data, including the value of the specified weather condition at the specified geographic site in each of a preselected number N of years prior to the two specified consecutive years, is applied to CPU 24 from data source 26. Data source 26 might be disks, tapes, tables, or other media obtained from the National Climatic Data Center containing historical data. Such data might be stored in a memory of data source 26 so that the disks, tapes, tables, or other media do not need to be repeatedly consulted. CPU 24 determines the probability of the average value of the specified weather being outside the specified limit during the specified season in the specified year or the two specified consecutive years. This number might be displayed on a display screen of output unit 28. CPU 24 might also determine the premium P for the policy and display that on output unit 28. Likewise, CPU 24 might apply the necessary information to a printer of output unit 28 to enable the printer to print the policy. CPU 24 may be programmed to enable it to perform all the necessary functions.

Although preferred embodiments of the present invention have been described, various alternatives, rearrangements, and substitutions might be made, and still the result would come within the scope of the invention.

What is claimed is:

1. A method of determining the probability L of the average value of a specified weather condition being outside of a specified limit for the weather condition during a specified season in two specified consecutive years at a specified geographic site, said method comprising:
acquiring data regarding the specified weather condition at the specified geographic site during the specified season in each of a preselected number N of years prior to the two specified consecutive years;
from the data, determining the number T of occurrences of the average value of the specified weather condition being outside the specified limit at the specified geographic site during the specified season in two consecutive years during the preselected number N of years; and
from the preselected number N of years and the number T of occurrences, determining the probability L of the average value of the specified weather condition being outside the specified limit at the specified geographic site during the specified season in the two specified consecutive years.

2. The method of claim 1, further comprising determining the premium P for a policy insuring in a specified amount A against the average value of the specified weather condition being outside the specified limit at the specified geographic site during the specified season in the two specified consecutive years.

3. The method of claim 2, further comprising preparing the policy.

4. The method of claim 2, in which P=(L+E)×A, where E is a value to provide overhead and profit.

5. The method of claim 2, in which P=L×A×C, where C is a constant to account for overhead and profit.

6. The method of claim 5, in which C=1.5.

7. The method of claim 2, in which P=L×A+E, where E is overhead and profit.

8. The method of claim 2, further comprising acquiring from a customer identification of the customer, the specified amount A, the specified geographic site, the specified weather condition, the specified limit, the specified season, and the two specified consecutive years.

9. The method of claim 8, further comprising preparing the policy for the customer.

10. The method of claim 1, wherein L=T÷N.

11. The method of claim 1, in which the specified weather condition is a type of temperature degree days, and the specified limit is a specified number D of that type of temperature degree days.

12. The method of claim 11, wherein the temperature degree days are cooling degree days.

13. The method of claim 11, wherein the temperature degree days are heating degree days.

14. The method of claim 1, wherein the specified season is the months of June, July, and August.

15. The method of claim 1, wherein the specified season is the months of December, January, and February.

16. The method of claim 1, wherein the specified season is a calendar year.

17. A method of determining the probability L of the average value of a specified weather condition being outside of a specified limit for the weather condition during a specified season in two specified consecutive years at a specified geographic site, said method comprising:
acquiring data regarding the specified weather condition at the specified geographic site during the specified season in each of a preselected number N of years prior to the two specified consecutive years;
from the data, identifying the occurrences of the average value of the specified weather condition being outside the specified limit at the specified geographic site during the specified season in two consecutive years during the preselected number N of years;
weighting each year in the preselected number N of years on the basis of the number of years since such year;
weighting each identified occurrence on the basis of the weight of one of its two years, and
from the weighted years and the weighted occurrences, determining the probability L of the average value of the specified weather condition being outside the specified limit at the specified geographic site during the specified season in the two specified consecutive years.

18. The method of claim 17, wherein:
the years are weighted by assigning to each of the years a value V equal to one more than the number of years between that year and the first one of the N years;
the values V are totaled to give a total weighted number Y for the years;
each occurrence is weighted by the value V of one of its two specified consecutive years;
the weighted values of the occurrences are totaled to give a total weighted number W for the occurrences; and
the probability L is determined as L=W÷Y.

19. The method of claim 17, further comprising determining the premium P for a policy insuring in a specified amount A against the average value of the specified weather condition being outside the specified limit at the specified geographic site during the specified season in the two specified consecutive years.

20. The method of claim 19, wherein determining the probability includes assigning a set of payout percentages to a set of triggering conditions, each triggering condition representing a preselected amount of the preselected limit, each payout percentage representing a preselected percentage of the specified amount A to be paid in the event the associated triggering condition is met during the preselected season in the preselected year.

21. The method of claim 19, further comprising preparing the policy.

22. The method of 19, in which P=(L+E)×A, where E is a value to provide overhead and profit.

23. The method of claim 19, in which P=L×A×C, where C is a Constant to account for overhead and profit.

24. The method of claim 23, in which C=1.5.

25. The method of claim 19, in which P=L×A+E, where E is overhead and profit.

26. The method of claim 19, further comprising acquiring from a customer identification of the customer, the specified amount A, the specified geographic site, the specified weather condition, the specified limit, the specified season, and the two specified consecutive years.

27. The method of claim 26, further comprising preparing the policy for the customer.

28. The method of claim 17, in which the specified weather condition is a type of temperature degree days, and the specified limit is a specified number D of that type of temperature degree days.

29. The method of claim 28, wherein the temperature degree days are cooling degree days.

30. The method of claim 28, wherein the temperature degree days are heating degree days.

31. The method of claim 17, wherein the specified season is the months of June, July, and August.

32. The method of claim 17, wherein the specified season is the months of December, January, and February.

33. The method of claim 17, wherein the specified season is a calendar year.

34. A method of determining the probability L of a specified weather condition being outside of a specified limit for the weather condition at a specified geographic site during a specified season in a specified year, said method comprising:
acquiring data regarding the specified weather condition at the specified geographic site during the specified season in each of a preselected number N of years prior to the specified year;
from the data, identifying the occurrences of the specified weather condition being outside the specified limit at the specified geographic site during the specified season in the preselected number N of years;
weighting each year in the preselected number N of years on the basis of the number of years since such year; and
weighting each identified occurrence on the basis of the weight of the corresponding year; and
from the weighted years and the weighted occurrences, determining the probability L of the specified weather condition being outside the specified limit at the specified geographic site during the specified season in the specified year.

35. The method of claim 34, wherein:
the years are weighted by assigning to each of the years a value V equal to one more than the number of years between that year and the first one of the N years;
the values V are totaled to give a total weighted number Y for the years;
each occurrence is weighted by the value V of the corresponding occurrence year;
the weighted values of the occurrences are totaled to give a total weighted number W for the occurrences; and
the probability L is determined as L=W÷Y.

36. The method of claim 34, further comprising determining the premium P for a policy insuring in a specified amount A against the occurrence of the specified weather condition being outside the specified limit at the specified geographic site during the specified season in the specified year.

37. The method of claim 36, wherein determining the probability includes assigning a set of payout percentages to a set of triggering conditions, each triggering condition representing a preselected amount of the preselected limit, each payout percentage representing a preselected percentage of the specified amount A to be paid in the event the associated triggering condition is met during the preselected season in the preselected year.

38. The method of claim 36, further comprising preparing the policy.

39. The method of claim 36, in which P=(L+E)×A, where E is a value to provide overhead and profit.

40. The method of claim 36, in which P=L×A×C, where C is a constant to account for overhead and profit.

41. The method of claim 40, in which C=1.5.

42. The method of claim 36, in which P=L×A+E, where E is overhead and profit.

43. The method of claim 36, further comprising acquiring from a customer identification of the customer, the specified amount A, the specified geographic site, the specified weather condition, the specified limit, the specified season, and the specified year.

44. The method of claim 43, further comprising preparing the policy for the customer.

45. The method of claim 34, wherein the specified weather condition and the specified limit comprise rain of less than a specified amount.

46. The method of claim 34, wherein the specified weather condition and the specified limit comprise rain of more than a specified amount.

47. The method of claim 34, wherein the specified season is the months of June, July, and August.

48. The method of claim 34, wherein the specified season is the months of December, January, and February.

49. The method of claim 34, wherein the specified season is a calendar year.

50. An article, comprising a storage medium having instructions stored thereon, the instructions when executed determining the probability L of the average value of a specified weather condition being outside of a specified limit for the weather condition during a specified season in two specified consecutive years at a specified geographic site by:
acquiring data regarding the specified weather condition at the specified geographic site during the specified season in each of a preselected number N of years prior to the two specified consecutive years;
from the data, determining the number T of occurrences of the average value of the specified weather condition being outside the specified limit at the specified geographic site during the specified season in two consecutive years during the preselected number N of years; and
from the preselected number N of years and the number T of occurrences, determining the probability L of the average value of the specified weather condition being outside the specified limit at the specified geographic site during the specified season in the two specified consecutive years.

51. The article of claim 50, wherein the instructions further determine the premium P for a policy insuring in a specified amount A against the average value of the specified weather condition being outside the specified limit at the specified geographic site during the specified season in the two specified consecutive years.

52. The article of claim 51, wherein the instructions further prepare the policy.

53. The article of claim 50, wherein the specified weather condition is a type of temperature degree days, and the specified limit is a specified number of that type of temperature degree days.

54. The article of claim 53, wherein the temperature degree days are cooling degree days.

55. The article of claim 53, wherein the temperature degree days are heating degree days.

56. An article, comprising a storage medium having instructions stored thereon, the instructions when executed determining the probability L of the average value of a specified weather condition being outside of a specified limit for the weather condition during a specified season in two specified consecutive years at a specified geographic site by:
acquiring data regarding the specified weather condition at the specified geographic site during the specified season in each of a preselected number N of years prior to the two specified consecutive years;
from the data, identifying the occurrences of the average value of the specified weather condition being outside the specified limit at the specified geographic site during the specified season in two consecutive years during the preselected number N of years;
weighting each year in the preselected number N of years on the basis of the number of years since such year;
weighting each identified occurrence on the basis of the weight of the later year of its two years, and
from the weighted years and the weighted occurrences, determining the probability L of the average value of the specified weather condition being outside the specified limit at the specified geographic site during the specified season in the two specified consecutive years.

57. The article of claim 56, wherein the instructions:
weight the years by assigning to each of the years a value V equal to one more than the number of years between that year and the first one of the N years;
total the values V to give a total weighted number Y for the years;
weight each occurrence by the value V of one of its two specified consecutive years;
total the weighted numbers of the occurrences to give a total weighted number W for the occurrences; and
determine the probability L as L=W÷Y.

58. The article of claim 56, wherein the instructions further determine the premium P for a policy insuring in a specified amount A against the average value of the specified weather condition being outside the specified limit at the specified geographic site during the specified season in the two specified consecutive years.

59. The article of claim 58, wherein the instructions further assign a set of payout percentages to a set of triggering conditions, each triggering condition representing a preselected amount of the preselected limit, each payout percentage representing a preselected percentage of the specified amount A to be paid in the event the triggering condition is met during the preselected season in the preselected year.

60. The article of claim 58, wherein the instructions further prepare the policy.

61. The article of claim 57, wherein the specified weather condition is a type of temperature degree days, and the specified limit is a specified number of that type of temperature degree days.

62. The article of claim 61, wherein the temperature degree days are cooling degree days.

63. The article of claim 61, wherein the temperature degree days are heating degree days.

64. An article, comprising a storage medium having instructions stored thereon, the instructions when executed determining the probability L of a specified weather condition being outside of a specified limit for the weather condition at a specified geographic site during a specified season in a specified year, said method comprising:
acquiring data regarding the specified weather condition at the specified geographic site during the specified season in each of a preselected number N of years prior to the specified year;
from the data, identifying the occurrences of the specified weather condition being outside the specified limit at the specified geographic site during the specified season in the preselected number N of years;
weighting each year in the preselected number N of years on the basis of the number of years since such year; and
weighting each identified occurrence on the basis of the weight of the corresponding year; and
from the weighted years and the weighted occurrences, determining the probability L of the specified weather condition being outside the specified limit at the specified geographic site during the specified season in the specified year.

65. The article of claim 64, wherein the instructions:
weight the years by assigning to each of the years a value V equal to one more than the number of years between that year and the first one of the N years;
total the values V to give a total weighted number Y for the years;
weight each occurrence by the value V of the corresponding occurrence year;
total the weighted numbers of the occurrences to give a total weighted number W for the occurrences; and
determine the probability L as L=W÷Y.

66. The article of claim 64, wherein the instructions further determine the premium P for a policy insuring in a specified amount A against the specified weather condition being outside the specified limit at the specified geographic site during the specified season in each of the two specified consecutive years.

67. The article of claim 66, wherein the instructions further assign a set of payout percentages to a set of triggering conditions, each triggering condition representing a preselected amount of the preselected limit, each payout percentage representing a preselected percentage of the specified amount A to be paid in the event the triggering condition is met during the preselected season in the preselected year.

68. The article of claim 66, wherein the instructions further prepare the policy.

69. The article of claim 64, wherein the specified weather condition is rain in excess of a specified amount.

70. The article of claim 64, wherein the specified weather condition is rain less than a specified amount.
